(19) United States
(12) Patent Application Publication
(10) Pub. No.: US 2019/0034944 A1
(43) Pub. Date: Jan. 31, 2019

(54) SYSTEMS AND METHODS FOR PREDICTING BUFFER VALUE

(71) Applicant: Walmart Apollo, LLC, Bentonville, AR (US)

(72) Inventors: Shaun Robert Rorrison, Bentonville, AR (US); Marv Hansen, Bella Vista, AR (US)

(21) Appl. No.: 16/045,041

(22) Filed: Jul. 25, 2018

Related U.S. Application Data
(60) Provisional application No. 62/537,104, filed on Jul. 26, 2017.

(51) Int. Cl. G06Q 30/02; G06Q 10/08; G06N 5/04

(52) U.S. Cl. CPC G06Q 30/0202; G06N 5/046; G06Q 10/083; G06Q 10/0875

(57) ABSTRACT

Systems and methods for predicting buffer values are discussed. A quantity data value is retrieved from a database for a receiving location associated with a processing location. A lower buffer value and a higher buffer value are predicted for a period of time based on received lower and higher confidence values and an effective lead time. The effective lead time is determined from the total processing time and a delivery time from the processing location to the receiving location. The lower and higher buffer values indicate a quantity in addition to the present quantity data value to meet variations in the demand value. A buffer data value is received that is more than the lower buffer value and less than the higher buffer value, and an order request is automatically generated and processed for supplying the buffer data value to the processing location.

### RELATED APPLICATION

This application claims priority to U.S. Provisional Application No. 62/537,104 filed on Jul. 26, 2017, the contents of which is hereby incorporated by reference in its entirety.

### BACKGROUND

Safety stock is inventory that is carried to prevent stockouts where an item is out of stock at a retail store. Stockouts may occur due to various factors, including variations in customer demand, inaccurate forecasting of demand, and variations in lead times for manufacturing and supplying product.

### SUMMARY

Exemplary embodiments of the present disclosure provide systems, methods, and computer readable medium for predicting buffer values.

In one embodiment, a system for predicting a buffer value is provided. The system includes an input module, a predictive analysis module, and an output module. The input module is configured to retrieve a quantity data value from a database for a receiving location associated with a processing location, and receive a lower confidence value and a higher confidence value that present quantity data value is sufficient to meet a demand value. The predictive analysis module is configured to predict a lower buffer value for a period of time based on the lower confidence value and an effective lead time. The effective lead time is determined from a total processing time and a delivery time from the processing location to the receiving location. The predictive analysis module is further configured to predict a higher buffer value for the period of time based on the higher confidence value and the effective lead time. The lower and higher buffer values indicate a buffer quantity in addition to the present quantity data value to meet variations in the demand value. The predictive analysis module is also configured to receive a buffer data value that is more than the lower buffer value and less than the higher buffer value. The output module is configured to automatically generate and process a request, at a server, for supplying the buffer data value to the processing location.

In another embodiment, a method for predicting a buffer value is provided. The method includes retrieving a quantity data value from a database for a receiving location associated with a processing location, and receiving a lower confidence value and a higher confidence value that present quantity data value is sufficient to meet a demand value. The method also includes predicting a lower buffer value for a period of time based on the lower confidence value and an effective lead time. The effective lead time is determined from a total processing time and a delivery time from the processing location to the receiving location. The method further includes predicting a higher buffer value for the period of time based on the higher confidence value and the effective lead time. The lower and higher buffer values indicate a buffer quantity in addition to the present quantity data value to meet variations in the demand value. The method includes receiving a buffer data value that is more than the lower buffer value and less than the higher buffer value, and automatically generating and processing a request, at a server, for supplying the buffer data value to the processing location.

In another embodiment, a non-transitory machine readable medium is provided that stores instructions that when executed causes a processor to implement a method for predicting a buffer value. The method includes retrieving a quantity data value from a database for a receiving location associated with a processing location, and receiving a lower confidence value and a higher confidence value that present quantity data value is sufficient to meet a demand value. The method also includes predicting a lower buffer value for a period of time based on the lower confidence value and an effective lead time. The effective lead time is determined from a total processing time and a delivery time from the processing location to the receiving location. The method further includes predicting a higher buffer value for the period of time based on the higher confidence value and the effective lead time. The lower and higher buffer values indicate a buffer quantity in addition to the present quantity data value to meet variations in the demand value. The method includes receiving a buffer data value that is more than the lower buffer value and less than the higher buffer value, and automatically generating and processing a request, at a server, for supplying the buffer data value to the processing location.

### BRIEF DESCRIPTION OF DRAWINGS

The accompanying drawings, which are incorporated in and constitute a part of this specification, illustrate one or more embodiments of the invention and, together with the description, help to explain the invention. The embodiments are illustrated by way of example and should not be construed to limit the present disclosure. In the drawings:

FIG. 1 is a block diagram showing a buffer prediction system implemented in modules, according to an example embodiment;

FIG. 2 is a flowchart showing an exemplary method for predicting buffer values, according to an example embodiment;

FIG. 3 is a schematic illustrating an exemplary system for predicting buffer values, according to an example embodiment;

FIG. 4 illustrates a network diagram depicting a system for implementing a distributed embodiment of the buffer prediction system, according to an example embodiment;

FIG. 5 is a block diagram of an exemplary computing device that can be used to implement exemplary embodiments of the buffer prediction system described herein; and

FIGS. 6A-6H illustrate graphs for buffer values predicted by the buffer prediction system, according to example embodiments.

### DESCRIPTION OF EXEMPLARY EMBODIMENTS

Exemplary embodiments of the present disclosure provide systems, methods and non-transitory computer readable medium for predicting a buffer value for safety stock. Safety stock is inventory that is carried to prevent stockouts where an item is out of stock at a retail store. Stockouts may occur due to various factors, including variations in customer demand, inaccurate forecasting of demand, and variations in lead times for manufacturing and supplying product. Some operations managers use gut feelings or hunches to set the level of safety stock, while others use a static portion or percentage for each demand cycle. Such techniques generally result in poor performance. Exemplary embodiments described herein predict safety stock or buffer values while balancing the two goals of maximizing customer service by reducing the risk of a stockout, and minimizing inventory cost.

Exemplary embodiments described herein provide efficiencies, including a reduction in the safety stock inventory investment and an increase in associate productivity, when compared to the logic and equations employed by conventional statistical safety stock calculations. Conventional safety stock calculations require an additional inventory investment that is unnecessary when the dynamic distribution, or postponement, principle is factored in as provided in exemplary embodiments. Exemplary embodiments improve associate productivity while hiding the complexity associated with predicting a safety stock value, and present the information to an associate in an easy to understand manner. In addition, storing the predicted buffer values and the algorithms used to predict the buffer values in an efficient guardrail process leaves room for flexibility and guidance when managing inventory. The exemplary system described herein also enables a qualified business expert to input qualitative data into the system, and the system takes the qualitative data in account when predicting the buffer values. Qualitative data may include industry insights of upcoming trends that may not be captured in historical data, but may still impact the optimal amount of inventory needed. Qualitative data may indicate information related to or based on new product introductions, emerging fashion trends, non-repeatable weather anomalies (e.g., hurricane or flood), competitor store closings, and the like.

Exemplary embodiments predict buffer values or safety stock values using a modified statistical safety stock equation. The lower and higher buffer values predicted by the system described herein may be referred to as guardrails. In an example embodiment, the calculation used to determine the guardrails is Z score×σ_{D}×\sqrt{lead time}, where D is customer demand, and rather than using the true lead time from a source to destination, in an example embodiment the lead time accounts for postponement by using an effective lead time component. In an non-limiting example use, to predict a lower and higher guardrail, a user inputs a higher service level of 99.2% for one calculation and a lower service level of 94%.

In order to increase associate efficiency, the complexity of calculating the safety stock is masked by the more easily understood terminology of an existing system that a replenishment manager is familiar with. The existing system may provide a translation of predicted buffer values and safety stock quantities into forward-looking ‘days of supply’ metric.

Using the logic described above, a predicted higher and lower safety stock value or buffer value is presented to a user in terms of the familiar existing system language. For example, 3 days of supply metric in the existing system is processed the same as taking the next 3 days of forecasted demand and using that quantity as the current day's buffer value or safety stock value. The user, often an inventory or operations manager of a retail store, can manage the store's safety stock settings based on the predicted safety stock guardrails.

The effective lead time component used in the exemplary modified safety stock calculation described herein leverages the supply chain management principle of postponement. Conventional safety stock calculations use the true lead time from one source to the following destination. The effective lead time used in exemplary embodiments shortens the “true” lead time required to move product from the source to destination. The modified safety stock calculation uses an effective lead time, keeping the amount of safety stock inventory required to a minimum.

Rather than providing a single safety stock value, exemplary embodiments provide a set of guardrails for the safety stock value for a user to operate within. Managing safety stock in this manner allows for strategic business decisions to be made, such as, increasing the inventory investment in one product category known to drive sales at a particular time while decreasing the investment in another product category whose success is not as critical at the same time during a season.

Exemplary embodiments also maintain language consistent with existing replenishment systems when referencing the predicted safety stock. The calculations used to predict the safety stock values or buffer values is hidden from the end user and the output is reformatted into the familiar existing system's days of supply terminology rather than presenting it as a calculated integer value. The system predicts the buffer value or safety stock value, and then translates it into a days of supply value by comparing the predicted value to a daily forecasted demand value in order to determine the days of supply value.

In exemplary embodiments, a system for predicting buffer values is provided. A quantity data value is retrieved from a database for a receiving location (e.g. a store) associated with a processing location (e.g. a distribution center). A lower confidence value and a higher confidence value are received, where the values indicate a confidence that the present quantity data value is sufficient to meet demand value. A lower buffer value is predicted for a period of time based on the lower confidence value and an effective lead time. A higher buffer value is predicted for the period of time based on the higher confidence value and the effective lead time. The effective lead time is determined from the total processing time and a delivery time from the processing location to the receiving location. The lower and higher buffer values indicate a safety stock quantity in addition to the present quantity data value to meet variations in the demand value. A buffer data value is received that is more than the lower buffer value and less than the higher buffer value, and an order request is automatically generated and processed for supplying the buffer data value to the processing location.

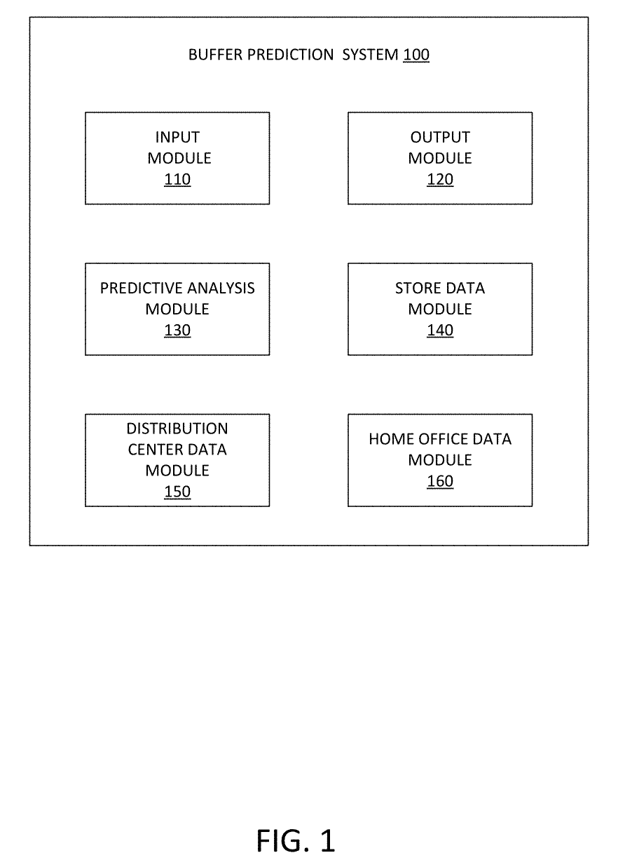

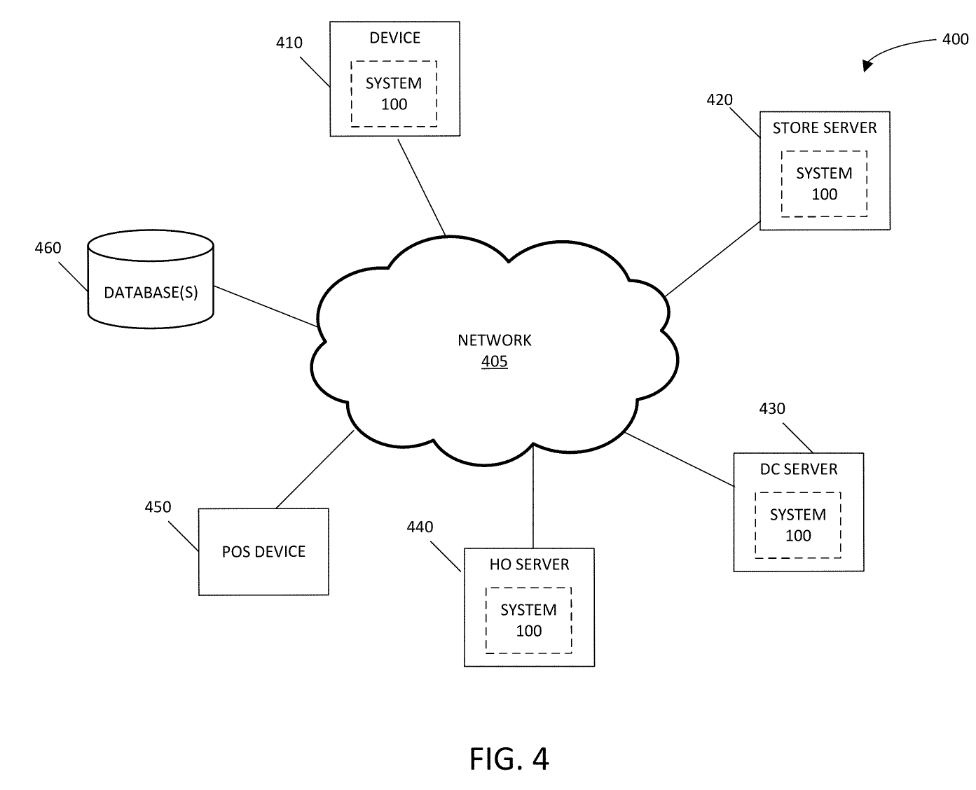

FIG. 1 is a block diagram showing a buffer prediction system 100 in terms of modules according to an example embodiment. One or more of the modules may be implemented using device 410, and/or servers 420, 430, 440 as shown in FIG. 4. The modules include an input module 110, an output module 120, a predictive analysis module 130, a store data module 140, a distribution center data module 150, and a home office data module 160. The modules may include various circuits, circuitry and one or more software components, programs, applications, or other units of code base or instructions configured to be executed by one or more processors. In some embodiments, one or more of modules 110, 120, 130, 140, 150, 160 may be included in servers 420, 430 or 440, while other of the modules 110, 120, 130, 140, 150, 160 are provided in device 410. Although modules 110, 120, 130, 140, 150, and 160 are shown as distinct modules in FIG. 1, it should be understood that modules 110, 120, 130, 140, 150, and 160 may be implemented as fewer or more modules than illustrated. It should be understood that any of modules 110, 120, 130, 140, 150 and 160 may communicate with one or more components included in system 400 (FIG. 4), such as device 410, store server 420, Distribution Center (DC) server 430, Home Office (HO) server 440, Point-of-Sale (POS) device 450, or database(s) 460.

The input module 110 may be a software or hardware-implemented module configured to retrieve and manage data used to predict lower and higher buffer values. The output module 120 may be a software or hardware-implemented module configured to generate and process order requests for supplying the buffer data value to a processing location (e.g., distribution center). The predictive analysis module 130 may be a software or hardware-implemented module configured to analyze data, and calculate and predict buffer values based on the data.

The store data module 140 may be a software or hardware-implemented module configured to manage and analyze sales data and inventory data at an individual receiving location (e.g., retail store). The buffer prediction system 100 may include a corresponding store data module 140 for each receiving location (retail store). The distribution center data module 150 may be a software or hardware-implemented module configured to manage and analyze inventory data at a processing location (e.g., distribution center), and calculate postponement time or lead time for buffer data values based on a receiving location's need for safety stock. The home office data module 160 may be a software or hardware-implemented module configured to calculate buffer data values for a processing location (e.g., distribution center) based on the needs of the receiving locations (e.g., retail stores) corresponding to the processing location. The home office data module 160 may also be configured to manage data for an order fulfillment system that facilitates fulfillment of order requests for inventory and stock, including safety stock.

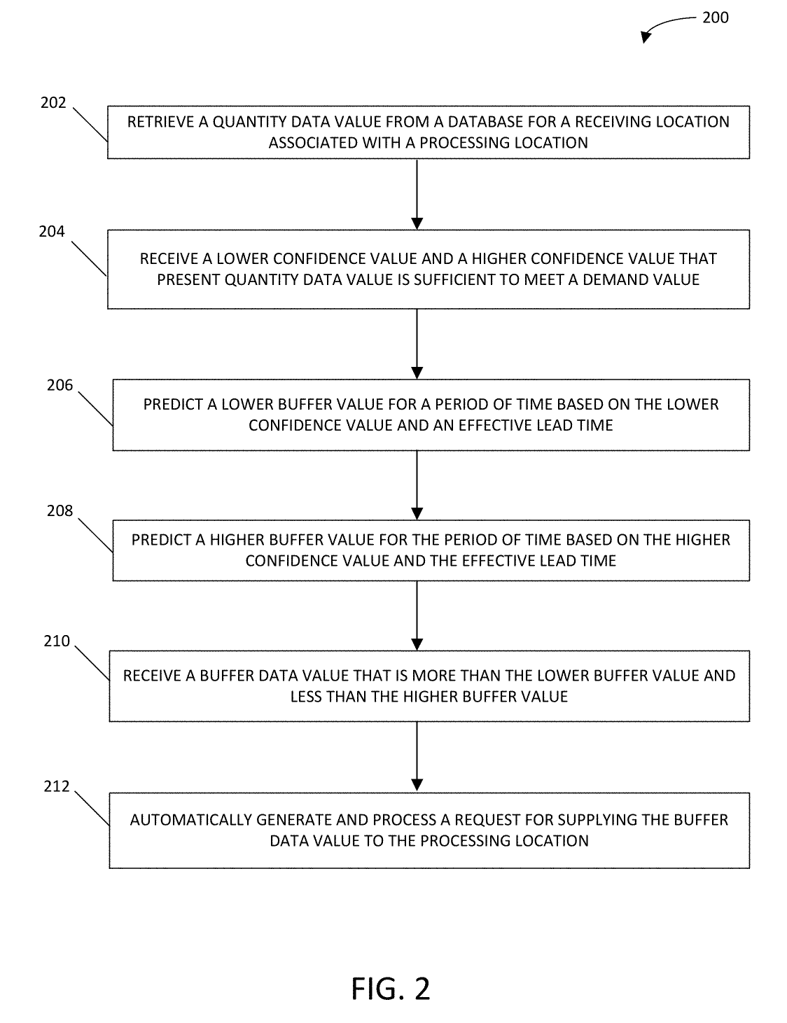

FIG. 2 is a flowchart showing an exemplary method for predicting a buffer value, according to an example embodiment. The method 200 may be performed using the modules in the buffer prediction system 100 shown in FIG. 1 and the components described with reference to FIG. 4.

At step 202, the input module 110 retrieves a quantity data value from a database for a receiving location associated with a processing location. In an example embodiment, the quantity data value is determined based on or derived from current inventory levels at the receiving location, historical inventory levels at the receiving location, forecasted inventory levels at the receiving location, historical customer demand at the receiving location, forecasted customer demand at the receiving locations, and other factors. The quantity data value may also be determined based on a time of year, season, holiday, weather and other factors that may affect customer demand and inventory levels.

In an example embodiment, the input module 110 may also retrieve data relating to other factors used to predict a buffer value for the receiving location. The other factors may include implementation hierarchy, qualitative and quantitative inputs from the receiving location, the processing location, the supplier location, and/or the home office (corporate) location. Users can choose to aggregate buffer values by a specific product or location hierarchy (e.g., department level, state level, regional level, category level, etc.). The buffer prediction system 100 applies the buffer values to all SKUs found within the chosen hierarchy.

Examples of inputs from the receiving location include, but is not limited to, sales data that can be used to capture the level of variability in sales. Examples of inputs from the processing location include, but is not limited to, variability related to order processing times and out-bound lead time variability.

Examples of inputs from the supplier location include, but is not limited to, on-time delivery service levels, in-bound lead time variability, order fill rate (does the supplier ship the full order quantity consistently or is there variability that needs to be accounted for).

Examples of inputs from the home office location include, but is not limited to, desired service levels.

At step 204, the input module 110 receives a lower confidence value and a higher confidence value that present quantity data value is sufficient to meet a demand value. The lower confidence value and the higher confidence value may be user inputs.

At step 206, the predictive analysis module 130 predicts a lower buffer value for a period of time based on the lower confidence value and an effective lead time. The effective lead time is the total processing time and the delivery time from the processing location to the receiving location. The lower buffer value indicates a buffer quantity in addition to the present quantity data value to meet variations in the demand value. The effective lead time may be determined at the server by analysis of historical effective lead times between the processing location and the receiving location.

At step 208, the predictive analysis module 130 predicts a higher buffer value for the period of time based on the higher confidence value and the effective lead time. The higher buffer value indicates a buffer quantity in addition to the present quantity data value to meet variations in the demand value.

In an example embodiment, the predictive analysis module 130 predicts the lower buffer value and higher buffer value by calculating the lower buffer value and the higher buffer value based on a standard deviation of historical demand values. The historical demand values may be derived from the historical sales data captured by the POS systems at the receiving location. The sales data may be stored in a database by the POS systems as sale transactions occur at the receiving location. The standard deviation of historical demand values may be based on analysis of historical demand values for at least 13 weeks or some other pre-defined period.

At step 210, the predictive analysis module 130 receives a buffer data value that is more than the lower buffer value and less than the higher buffer value. In this manner, the predictive analysis module 130 provides guardrails (an upper guardrail and a lower guardrail) to a user to aid in choosing a final buffer value or safety stock value for the receiving location.

At step 212, the output module 120 automatically generates and processes a request for supplying the buffer data value to the processing location. The request for supplying the buffer data value may be generated on a specific day based on an actual lead time, where the actual lead time refers to the total processing time and delivery time from a supply location to the processing location. The actual lead time may be determined at a server by analysis of past actual lead times between the supply location and the processing location.

In an example embodiment, the predictive analysis module 130 generates a user interface and displays the predicted lower buffer value and the predicted higher buffer value in graphical format in the user interface.

In an example embodiment, the input module 110 may retrieve a quantity data value for multiple receiving locations associated with the processing location. The predictive analysis module 130 predicts the lower buffer value and the higher buffer value for each of the multiple receiving locations, and the effective lead time is the total processing time and delivery time from the processing location to the respective receiving location. The predictive analysis module 130 receives the buffer data value for each of the multiple receiving locations. The output module 120 calculates a total buffer data value by aggregating the buffer data value for each of the multiple receiving locations, and automatically generates and processes the request for supplying the total buffer data value to the processing location.

The buffer prediction system 100 may employ an algorithm to calculate the lower and higher buffer values described herein. In an example embodiment, the algorithm is:

buffer value=Z_{Guard CL %}×σ_{D}×\sqrt{LT}

where, Z_{Guard CL %} is the statistical measure of the desired confidence level of not experiencing a stock-out; σ_{D} is a measure of variation of historical sales data; and \sqrt{LT} is a factor of the adjusted lead time input.

In a non-limiting example, the confidence or service level CL %=98.9%, Z_{Guard CL %}=2.26, variation in historical sales data σ_{D}, =6.59, and \sqrt{LT}=2.83 (where the lead time is 8 days).

buffer value=2.26×6.59×2.83=42.08.

Using these example values and the algorithm above, the calculated buffer value is 42.08. The buffer prediction system 100 converts the calculated buffer value to days of supply, in this example, 3.77 days of supple (DOS).

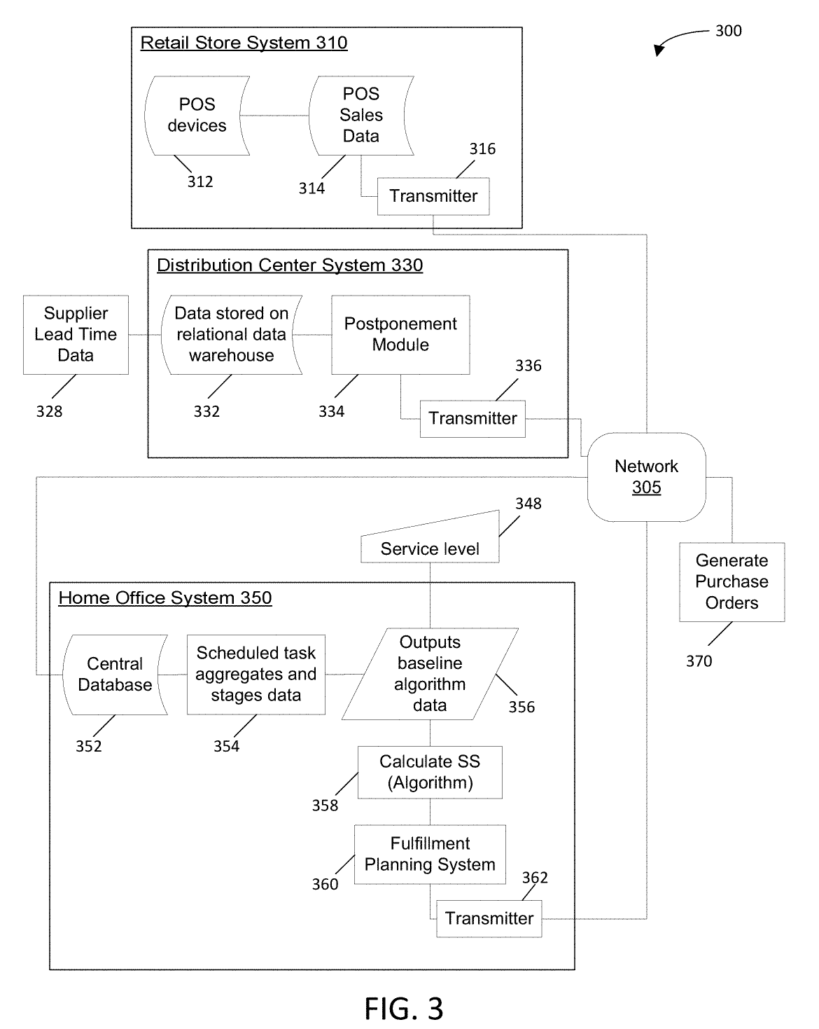

FIG. 3 is a schematic illustrating an exemplary system 300 for predicting buffer values, according to an example embodiment. The system 300 includes a retail store system 310, distribution center system 330 and a home office system 350 in communication with network 305.

The retail store 310 includes one or more Point-of-Sale (POS) devices 312. The POS devices 312 receive data related to transactions performed at the POS devices. The data may include sales data, item or product information, item or product identifier, and other data related to the transactions performed at the POS devices. The data may be input at the POS devices 312 via various input devices, including a keyboard or a scanner. The POS data 314 includes data from the POS devices 312. The POS data 314 may also include data retrieved from an inventory database. The transmitter 316 is configured to prepare and transmit the POS data 314 to the network 305. The transmitter 316 includes various circuits, circuitry and one or more software components, programs, applications, or other units of code base or instructions configured to be executed by one or more processors. The transmitter 316 may be a module implemented in a server or a computing device, and may be configured to transmit registered POS data to a centralized virtual or physical network that can be accessed by other systems (for example, the distribution system 330 or the home office system 350).

The distribution center system 330 receives supplier lead time data 328. The supplier lead time data 328 may be stored in a database, or may be provided by a third-party system that is hosted and maintained by a supplier. The supplier lead time data 328 includes the time for processing a purchase order by the supplier, and the time for delivering the purchase order to the distribution center. The distribution center system 330 includes data 332 stored in a relational data warehouse. Data 332 may include inbound lead time information and outbound lead time information. Inbound lead time information refers to the lead time for receiving (inbound) shipments, products, inventory etc. at the distribution center. Inbound lead time may be determined based on lead time for receiving inventory from a supplier. The inbound lead time is the time it takes for inventory to reach the distribution center from the supplier once an order request is transmitted. The inbound lead time may also take into account any delays caused by the supplier in fulfilling the order request, weather conditions, traffic conditions, and other factors that may affect fulfillment of the order by the supplier. Outbound lead time information refers to the lead time for sending (outbound) shipments, products, inventory, etc. from the distribution center to respective retail stores. Outbound lead time may be determined based on lead time for a particular retail store to receive inventory from the distribution center. The outbound lead time is the time it takes for inventory to reach the retail store from the distribution center once an order request is transmitted by the retail store. The outbound lead time may also take into account any delays caused by the distribution center in fulfilling the order request from the retail store, weather conditions, traffic conditions, and other factors that may affect fulfillment of the order by the distribution center.

The distribution center system 330 includes a postponement module 334 that is configured to determine and adjust lead time based on the inventory needs of a retail store. In an example embodiment, the lead time is adjusted based on the actual need or actual demand determined by the retail store. The buffer prediction system takes into account real-time fluctuations in sales, and enables a retail store to order safety stock accordingly. The distribution center that services the retail store is able to fulfill the order, and may re-route incoming inventory to a retail store that has a higher demand for the inventory than another retail store that has a lower demand for inventory. This effectively shortens the amount of time the retail store with the higher demand has to wait to receive additional inventory, since the safety stock order is being fulfilled by the distribution center rather than a supplier. The postponement module 334 includes various circuits, circuitry and one or more software components, programs, applications, or other units of code base or instructions configured to be executed by one or more processors. The postponement module 334 may be a module implemented in a server or a computing device.

The distribution center system 330 includes a transmitter 336. The transmitter 336 is configured to prepare and transmit lead time data to the network 305. The transmitter 336 includes various circuits, circuitry and one or more software components, programs, applications, or other units of code base or instructions configured to be executed by one or more processors. The transmitter 336 may be a module implemented in a server or a computing device, and may be configured to transmit registered adjusted lead time data to a centralized virtual or physical network that can be accessed by other systems (for example, the retail store system 310 or the home office system 350).

The home office system 350 receives service level data 348. The service level data refers to the desired level of confidence that the retail store will not run of stock. The level of confidence is used when predicting the buffer value or safety stock value for the retail store required to meet the desired level of confidence. For example, a 98% of service level means that the retail store is 98% confident that there will be enough inventory to avoid a stock out. But due to exponential costs associated with carrying buffer or safety inventory as desired confidence increases (for e.g. to 100%), the retail store is willing to accept a stock out 2% of the time. The home office system 350 includes a central database 352. The central database 352 may store data relating to multiple distribution centers (e.g., processing locations) and multiple stores (e.g. receiving locations). The central database 352 may store data related to product and location hierarchy, including but not limited to, item identifying information and store identifying information. The central database 352 stores the data transmitted from the retail store system 310 and the distribution center system 330 that is used by the buffer prediction system to predict buffer values or safety stock values

At block 354, the home office system 350 aggregates and stages data according to a scheduled task. In an example embodiment, the home office system 350 at block 352 retrieves data from the central database 352 (which stores data collected and transmitted by the retail store system 310 and the distribution center system 330), combines it with product and location information, and transforms the data so that it can be used an inputs into the algorithm used to calculate the lower and higher buffer or safety stock values. The calculated buffer values are later transformed to ‘days of supply’ metric that is a term used by the existing replenishment system

At block 356, the home office system 350 outputs baseline algorithm data. All data feeds are consolidated at block 356. At block 358, the home office system 358 calculates a lower buffer and a higher buffer value. Calculations, including conversion of the buffer value into a days of supply metric are performed at block 358. In an example embodiment, the baseline algorithm is used to predict the lower and higher buffer or safety stock values. The baseline algorithm takes as inputs the data provided by the home office system 350 at block 354, and outputs buffer values.

The output is sent to the fulfillment planning system 360 that is configured to replenish inventory at various distribution centers and corresponding retail stores. The purpose of replenishment is to keep inventory flowing through the supply chain by maintaining efficient order and line item fill rates.

The home office system 350 includes a transmitter 362. The transmitter 362 is configured to prepare and transmit data from the fulfillment planning system 360 to the centralized network 305. The transmitter 362 includes various circuits, circuitry and one or more software components, programs, applications, or other units of code base or instructions configured to be executed by one or more processors. The transmitter 362 may be a module implemented in a server or a computing device.

At block 370, purchase orders are generated for each retail store based on the data received from the transmitter 316, the transmitter 336 and the transmitter 362. The purchase order for a retail store is an order request for a buffer amount of stock or inventory to accommodate variations in customer demand at the store. In an example embodiment, the purchase order for a retail store is an order request for an amount of stock or inventory, raw demand plus newly generated buffer recommendation, to accommodate variations in customer demand at the store.

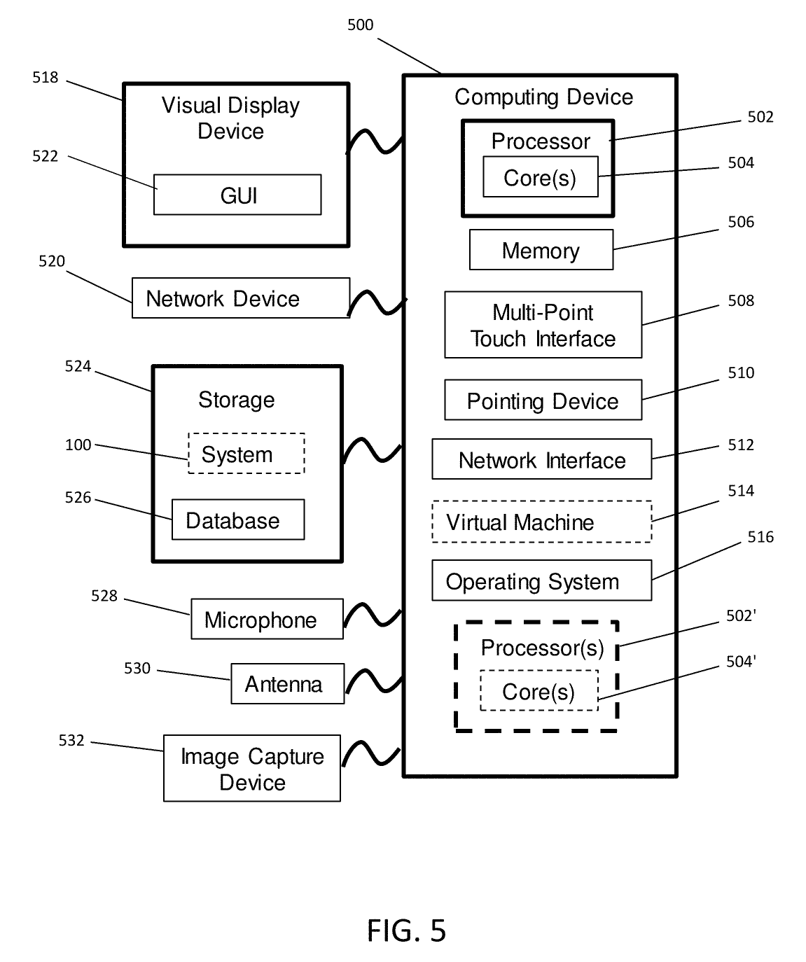

The retail store system 310, the distribution center system 330, and the home office system 350 are implemented in a geographically distributed system. Each of the retail store system 310, the distribution center system 330, and the home office system 350 may be implemented using one or more computing devices and/or servers. Each of the retail store system 310, the distribution center system 330, and the home office system 350 may include one or more components of the computing device 500 described in relation with FIG. 5.

The buffer value for safety stock predicted by the buffer prediction system described herein may not eliminate all stockouts, but can reduce the risk of a majority of them occurring. For example, when the buffer values are predicted for a 95 percent service level, it is expected that approximately 50 percent of the time, all the stock will not be depleted and the safety stock will not be used. For another 45 percent of the time, the safety stock will be needed and will suffice to meet customer demand. In approximately 5 percent of the time, a stockout is expected. To lower the risk of a stockout (less than 5 percent), a user can input a service level of 98 percent into the buffer prediction system described herein. However, this would require a significant amount of safety stock, which would increase inventory and operational costs for the retail store. A user may choose a service level that aids in balancing inventory costs and customer service levels.

In some embodiments, the receiving location may be a store and the processing location may be a distribution center. In other embodiments, the receiving location may be a distribution center and the processing location may be a supplier.

In an example embodiment, the buffer prediction system compares historical stock values with current stock values at a receiving location to determine the buffer value for safety stock for the receiving location. In some embodiments, the current stock values may be determined in real-time by scanning the current stock at the receiving location. The current stock at the receiving location may be automatically scanned using drones or other automated techniques. For example, a drone may be programmed to traverse aisles in a receiving location and scan the items on the shelves to determine the current stock values at the receiving location.

In other embodiments, the current stock values may be determined using RFID tags attached to items or pallets of items. In some other embodiments, the current stock values may be determined by analyzing images of stock using machine vision or video analytics techniques.

The stock in the storage or backroom at the receiving location may also be scanned to determine the current stock values. In an example embodiment, the stock may be scanned while being unloaded from a truck.

In one embodiment, stock in a receiving location may be scanned via a customer's augmented reality (AR) apparatus. The buffer prediction system can be configured to process images received from the AR apparatus. In some embodiments, the buffer prediction system may process AR images captured for a certain radius around the customer. The radius for processing may depend on the number of customers transmitting AR data in the particular aisle. For example, if there are many customers transmitting AR data for a particular aisle, then the radius of processing is smaller. If there are fewer customers transmitting AR data for a particular aisle, then the radius of processing is larger.

The current stock values may be determined or updated periodically based on various factors. For example, the current stock values may be determined or updated more frequently during high customer traffic periods. The current stock values for certain types of items or departments may be determined or updated more often than other types of items or departments. For example, current stock values of perishable foods, hot items, produce, etc. may be determined or updated more frequently than clothing items.

The current stock values obtained as discussed above may be used by the retail store system 310 in addition to POS sales data 314 to provide current inventory data to the buffer prediction system to determine a buffer value for safety stock.

FIG. 4 illustrates a network diagram depicting a system 400 for implementing a distributed embodiment of the buffer prediction system, according to an example embodiment. The system 400 can include a network 405, device 410, store server 420, Distribution Center (DC) server 430, Home Office (HO) server 440, Point-of-sale (POS) device 450, and database(s) 460. Each of components 410, 420, 430, 440, 450 and 460 is in communication with the network 405.

In an example embodiment, one or more portions of network 405 may be an ad hoc network, an intranet, an extranet, a virtual private network (VPN), a local area network (LAN), a wireless LAN (WLAN), a wide area network (WAN), a wireless wide area network (WWAN), a metropolitan area network (MAN), a portion of the Internet, a portion of the Public Switched Telephone Network (PSTN), a cellular telephone network, a wireless network, a WiFi network, a WiMax network, any other type of network, or a combination of two or more such networks.

The device 410 may include, but is not limited to, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, mini-computers, and the like. The device 410 can include one or more components described in relation to computing device 500 shown in FIG. 5.

The POS device 450 may include, but is not limited to, processor-equipped cash registers, work stations, computers, general purpose computers, Internet appliances, hand-held devices, wireless devices, portable devices, wearable computers, cellular or mobile phones, portable digital assistants (PDAs), smart phones, tablets, ultrabooks, netbooks, laptops, desktops, multi-processor systems, microprocessor-based or programmable consumer electronics, mini-computers, and the like. The POS device 410 can include one or more components described in relation to computing device 500 shown in FIG. 5.

The POS device 450 may be part of a store infrastructure and aid in performing various transactions related to sales and other aspects of a retail store. The POS device 450 may also include various external or peripheral devices to aid in performing transactions and other tasks. Examples of peripheral devices include, but are not limited to, barcode scanners, cash drawers, monitors, touch-screen monitors, clicking devices (e.g., mouse), input devices (e.g., keyboard), receipt printers, coupon printers, payment terminals, pin pad, and the like.

The device 410 may connect to network 405 via a wired or wireless connection. The device 410 may include one or more applications such as, but not limited to, replenishment system, inventory management system, sales management, and a buffer value prediction system described herein.

In an example embodiment, the device 410 may perform all the functionalities described herein. In other embodiments, the buffer prediction system 100 may be included on the device 410, and the servers 420, 430, 440 perform the functionalities described herein. In yet another embodiment, the device 410 may perform some of the functionalities, and the servers 420, 430, 440 perform the other functionalities described herein.

The store server 420 may include one or more components of the buffer prediction system 100. The store server 420 may be configured to perform one or more functionalities described herein. In an example embodiment, the store server 420 may include one or more components of the retail store system 310. The store server 420 may host systems and facilitate operations for a particular retail store. Each retail store may be associated with its own store server.

The DC server 430 may include one or more components of the buffer prediction system 100. The DC server 430 may be configured to perform one or more functionalities described herein. In an example embodiment, the DC server 430 may include one or more components of the distribution center system 330. The DC server 430 may host systems and facilitate operations for a particular distribution center. Each distribution center may be associated with its own DC server.

The HO server 440 may include one or more components of the buffer prediction system 100. The HO server 440 may be configured to perform one or more functionalities described herein. In an example embodiment, the HO server 440 may include one or more components of the home office system 350.

Each of the servers 420, 430, 440, and the database(s) 460 is connected to the network 405 via a wired or wireless connection. The servers 420, 430, 440 includes one or more computers or processors configured to communicate with the device 410, POS device 450, and database(s) 460 via network 405. The servers 420, 430, 440 host one or more applications, websites or systems accessed by the device 410 and POS device 450 and/or facilitates access to the content of database(s) 460. Database(s) 460 comprise one or more storage devices for storing data and/or instructions (or code) for use by the device 410, the servers 420, 430, 440, and the POS device 450. The database(s) 460, and/or the servers 420, 430, 440, may be located at one or more geographically distributed locations from each other or from the device 410 and the POS device 450. Alternatively, the database(s) 460 may be included within one of the servers 420, 430 or 440.

FIG. 5 is a block diagram of an exemplary computing device 500 that may be used to implement exemplary embodiments of the buffer prediction system 100 described herein. The computing device 500 includes one or more non-transitory computer-readable media for storing one or more computer-executable instructions or software for implementing exemplary embodiments. The non-transitory computer-readable media may include, but are not limited to, one or more types of hardware memory, non-transitory tangible media (for example, one or more magnetic storage disks, one or more optical disks, one or more flash drives), and the like. For example, memory 506 included in the computing device 500 may store computer-readable and computer-executable instructions or software for implementing exemplary embodiments of the buffer prediction system 100. The computing device 500 also includes configurable and/or programmable processor 502 and associated core 504, and optionally, one or more additional configurable and/or programmable processor(s) 502′ and associated core(s) 504′ (for example, in the case of computer systems having multiple processors/cores), for executing computer-readable and computer-executable instructions or software stored in the memory 506 and other programs for controlling system hardware. Processor 502 and processor(s) 502′ may each be a single core processor or multiple core (504 and 504′) processor.

Virtualization may be employed in the computing device 500 so that infrastructure and resources in the computing device may be shared dynamically. A virtual machine 514 may be provided to handle a process running on multiple processors so that the process appears to be using only one computing resource rather than multiple computing resources. Multiple virtual machines may also be used with one processor.

Memory 506 may include a computer system memory or random access memory, such as DRAM, SRAM, EDO RAM, and the like. Memory 506 may include other types of memory as well, or combinations thereof.

A user may interact with the computing device 500 through a visual display device 518, such as a computer monitor, which may display one or more graphical user interfaces 522 that may be provided in accordance with exemplary embodiments. The computing device 500 may include other I/O devices for receiving input from a user, for example, a keyboard or any suitable multi-point touch interface 508, a pointing device 510 (e.g., a mouse), a microphone 528, and/or an image capturing device 532 (e.g., a camera or scanner). The multi-point touch interface 508 (e.g., keyboard, pin pad, scanner, touch-screen, etc.) and the pointing device 510 (e.g., mouse, stylus pen, etc.) may be coupled to the visual display device 518. The computing device 500 may include other suitable conventional I/O peripherals.

The computing device 500 may also include one or more storage devices 524, such as a hard-drive, CD-ROM, or other computer readable media, for storing data and computer-readable instructions and/or software that implement exemplary embodiments of the buffer prediction system 100 described herein. Exemplary storage device 524 may also store one or more databases for storing any suitable information required to implement exemplary embodiments. For example, exemplary storage device 524 can store one or more databases 526 for storing information, such the quantity data value, demand value, predicted buffer values, the inputted buffer data value, and/or any other information to be used by embodiments of the system 100. The databases may be updated manually or automatically at any suitable time to add, delete, and/or update one or more items in the databases.

The computing device 500 can include a network interface 512 configured to interface via one or more network devices 520 with one or more networks, for example, Local Area Network (LAN), Wide Area Network (WAN) or the Internet through a variety of connections including, but not limited to, standard telephone lines, LAN or WAN links (for example, 802.11, T1, T3, 56 kb, X.25), broadband connections (for example, ISDN, Frame Relay, ATM), wireless connections, controller area network (CAN), or some combination of any or all of the above. In exemplary embodiments, the computing device 500 can include one or more antennas 530 to facilitate wireless communication (e.g., via the network interface) between the computing device 500 and a network. The network interface 512 may include a built-in network adapter, network interface card, PCMCIA network card, card bus network adapter, wireless network adapter, USB network adapter, modem or any other device suitable for interfacing the computing device 500 to any type of network capable of communication and performing the operations described herein. Moreover, the computing device 500 may be any computer system, such as a workstation, desktop computer, server, laptop, handheld computer, tablet computer (e.g., the iPad™ tablet computer), mobile computing or communication device (e.g., the iPhone™ communication device), point-of sale terminal, internal corporate devices, or other form of computing or telecommunications device that is capable of communication and that has sufficient processor power and memory capacity to perform the operations described herein.

The computing device 500 may run any operating system 516, such as any of the versions of the Microsoft® Windows® operating systems, the different releases of the Unix and Linux operating systems, any version of the MacOS® for Macintosh computers, any embedded operating system, any real-time operating system, any open source operating system, any proprietary operating system, or any other operating system capable of running on the computing device and performing the operations described herein. In exemplary embodiments, the operating system 516 may be run in native mode or emulated mode. In an exemplary embodiment, the operating system 516 may be run on one or more cloud machine instances.

In a non-limiting example, the buffer prediction system described herein employs the following equation to predict a buffer value: (Z_{Guard CL}%*σ_{D}*√LT Channel)/Avg daily sales channel, where Z_{Guard CL %} is the desired confidence level of not taking a stock out, σ_{D} is a measure of variation of historical sales data, and √LT Channel is a factor of the adjusted lead time input. The lead time is adjusted based on actual need (demand) found at the retail stores. As sales suddenly spike or drop off across various stores serviced by a distribution center, the buffer prediction system is able to re-route incoming product to a location that has a higher demand for that product—effectively shortening the amount of time a particular retail store has to wait before receiving product. Since the amount of time it takes to receive product is then shortened, the buffer prediction system does not use the true lead time value, and instead uses the adjusted value.

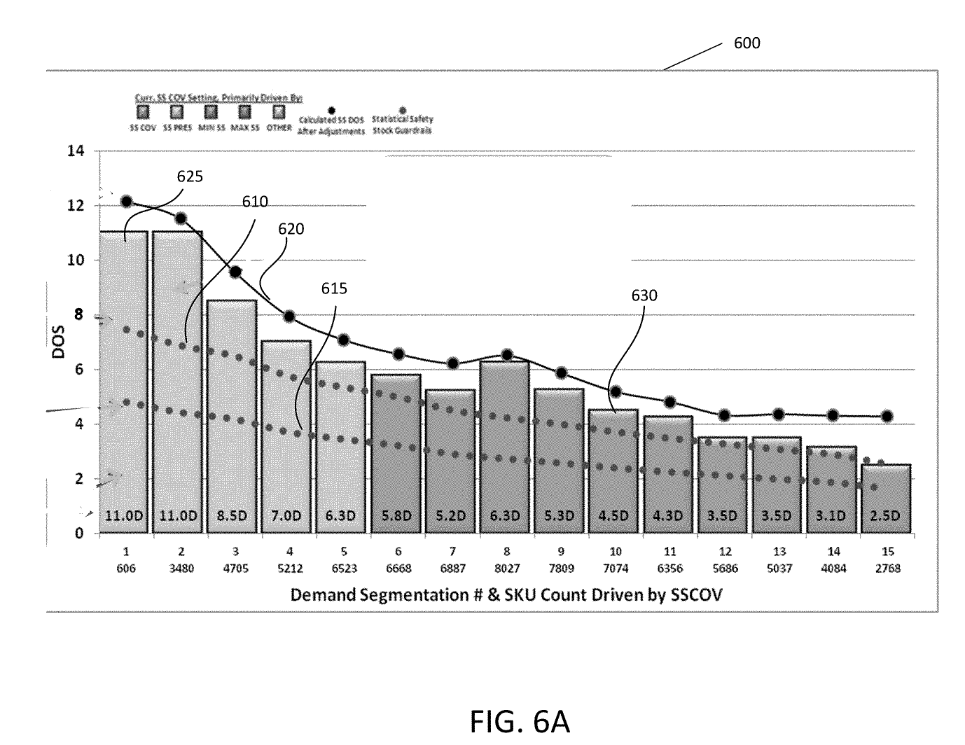

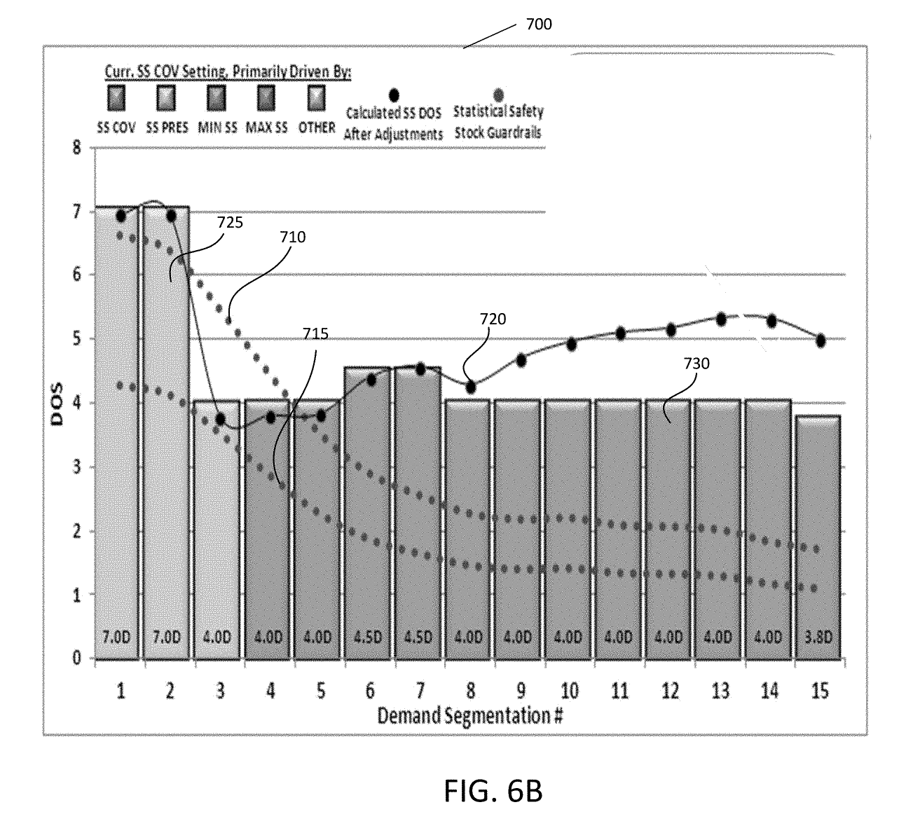

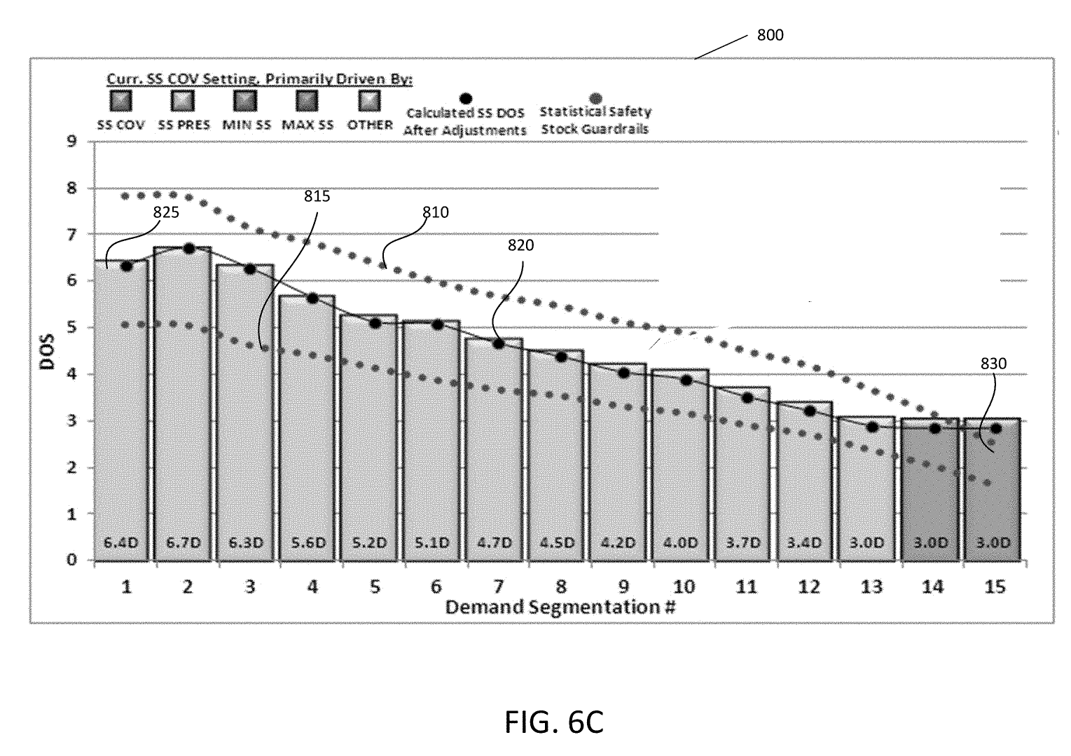

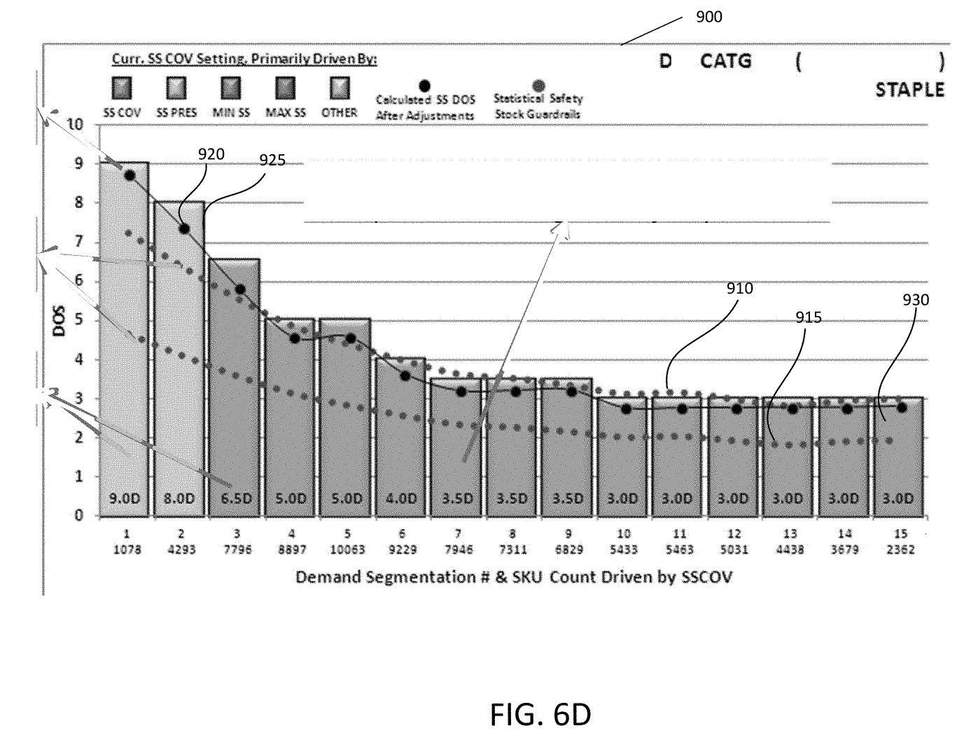

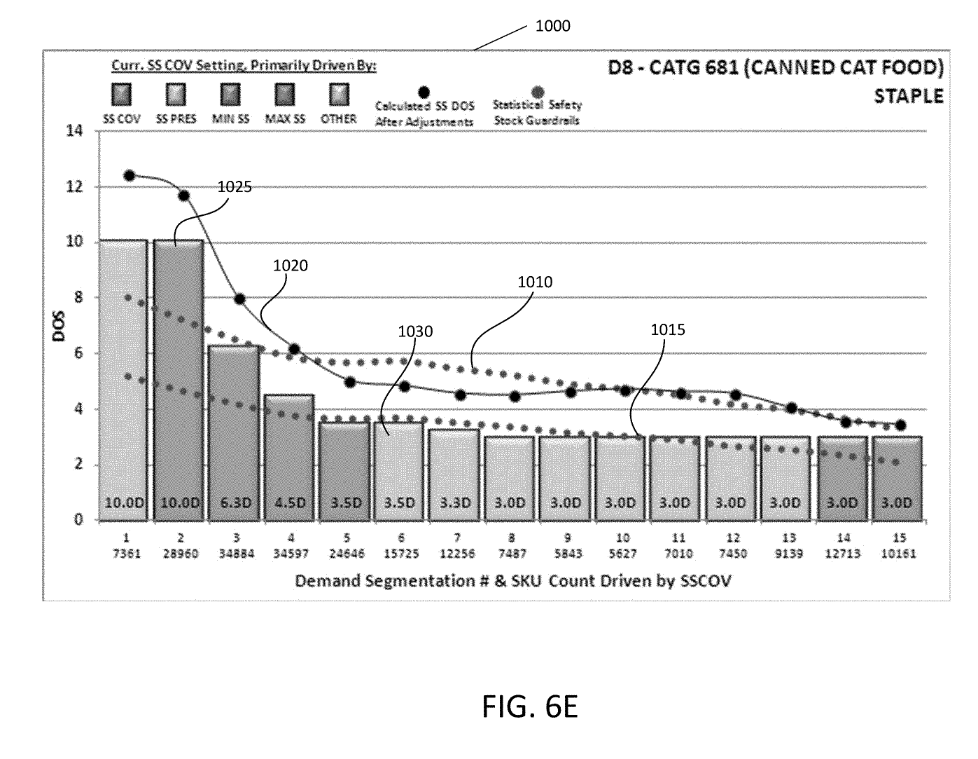

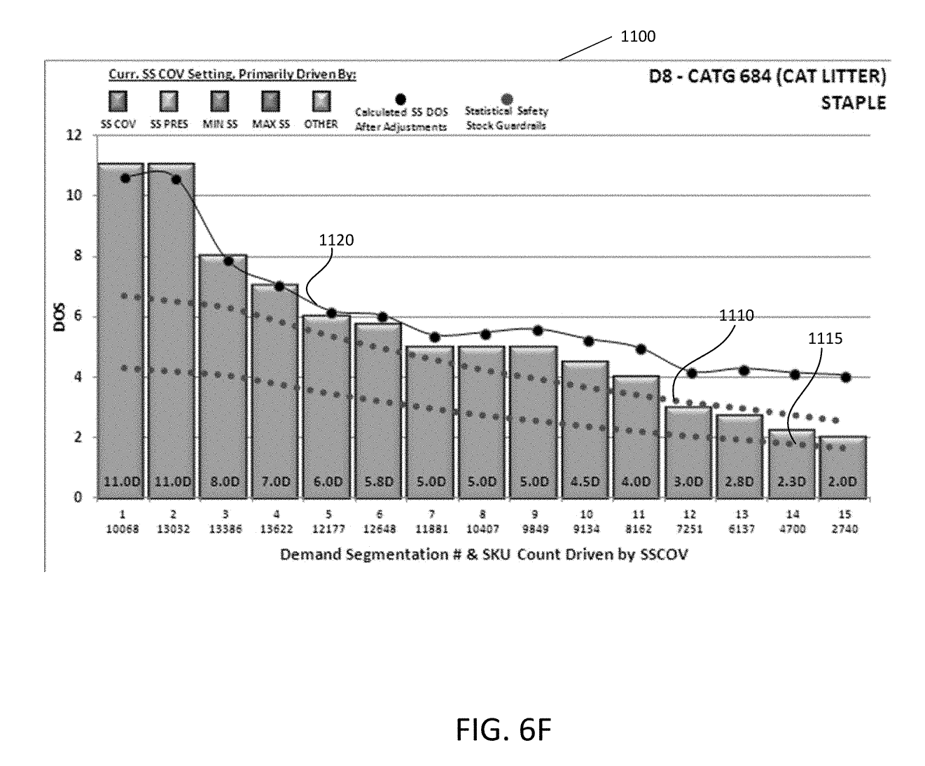

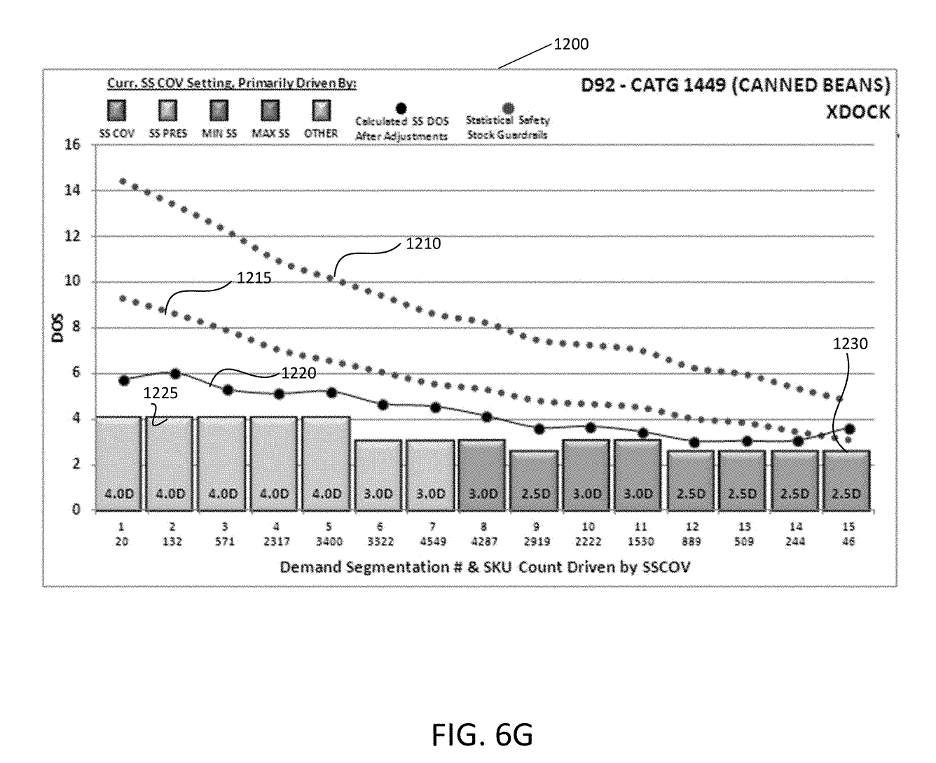

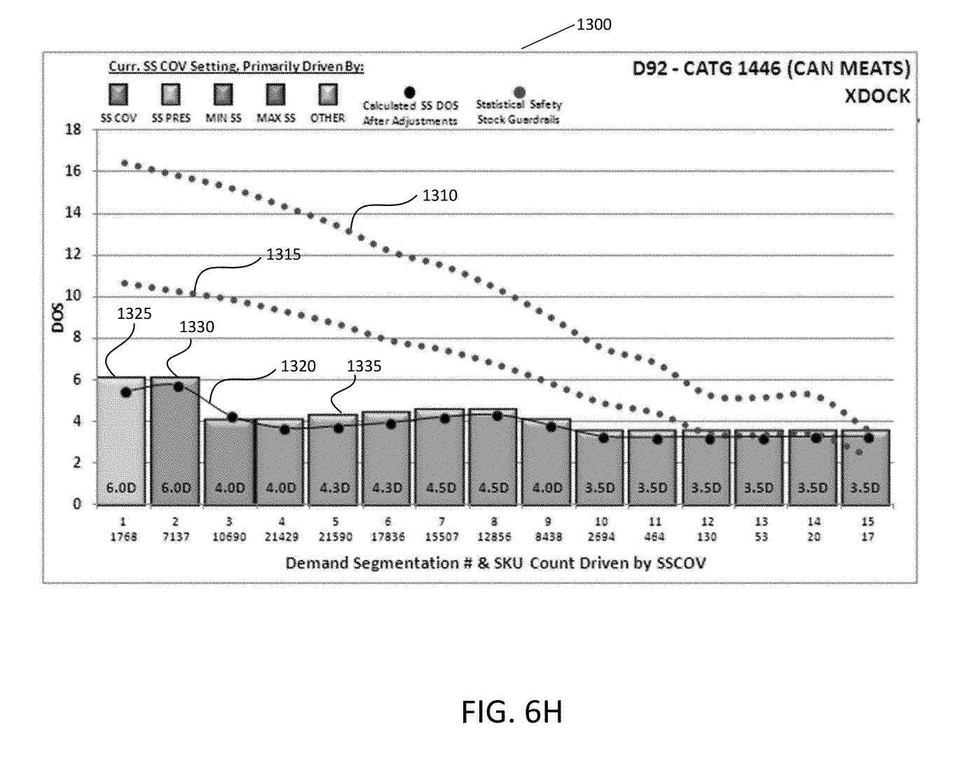

FIG. 6A is a graph 600 showing the days of supply (DOS, y-axis) for various store-item combinations (x-axis) produced in an exemplary embodiment. Graph 600 shows the buffer value or safety stock settings used to impact purchase order quantities/requests versus the predicted/calculated values outputted by the buffer prediction system described herein. Graph 600 also shows that the safety stock calculated using conventional systems results in too little safety stock to support demand needs. Graph 600 may be displayed in a user interface, and shows an aggregate view of all store-item combinations that are impacted by the conventional system and by the buffer prediction system described herein.

The safety stock amount determined using conventional systems is illustrated by the bars (e.g., bars 625 and 630) in graph 600. The line 610 is the higher buffer value or higher safety stock value calculated by the buffer prediction system described herein. The line 615 is the lower buffer value or lower safety stock value calculated by the buffer prediction system described herein. The line 620 in graph 600 represents other external factors that drive additional safety stock inventory to a store that may produce a slightly different inventory position than may be expected via the inputs into the buffer prediction system alone.

FIG. 6B is a graph 700 showing the days of supply (DOS-y-axis) for various store-item combinations (x-axis) produced in an exemplary embodiment. The line 710 is the higher buffer value or higher safety stock value calculated by the buffer prediction system described herein. The line 715 is the lower buffer value or lower safety stock value calculated by the buffer prediction system described herein. The line 720 in graph 700 represents other external factors that drive additional safety stock inventory to a store that may produce a slightly different inventory position than may be expected via the inputs into the buffer prediction system alone. In one embodiment, incremental days of supply of safety stock are added to the base safety stock value being calculated by the system to account for other external factors that drive additional safety stock inventory to a store and results in a slightly different inventory position than would be expected via the calculated settings alone. The bars (e.g., 725 and 730) in the graph 700 represent the inventory level for a particular product or item.

FIG. 6C is a graph 800 showing the days of supply (DOS-y-axis) for various store-item combinations (x-axis) produced in an exemplary embodiment. The line 810 is the higher buffer value or higher safety stock value calculated by the buffer prediction system described herein. The line 815 is the lower buffer value or lower safety stock value calculated by the buffer prediction system described herein. The line 820 in graph 800 represents other external factors that drive additional safety stock inventory to a store that may produce a slightly different inventory position than may be expected via the inputs into the buffer prediction system alone. In one embodiment the other external factors may be removed to bring total safety stock inventory levels within compliance of calculated tolerances. The bars (e.g., 825 and 830) in the graph 800 represent the inventory level for a particular product or item.

FIG. 6D is a graph 900 showing the days of supply (DOS-y-axis) for various store-item combinations (x-axis) produced in an exemplary embodiment. The line 910 is the higher buffer value or higher safety stock value calculated by the buffer prediction system described herein. The line 915 is the lower buffer value or lower safety stock value calculated by the buffer prediction system described herein. The line 920 in graph 900 represents other external factors that drive additional safety stock inventory to a store that may produce a slightly different inventory position than may be expected via the inputs into the buffer prediction system alone. In an example embodiment, the bars are shaded differently to show a user which factors are driving the inventory level calculation. For example, bar 925 has a different color or shaded color than bar 930 to indicate to the user that different factors are driving the inventory level for the product represented by bar 925 than for the product represented by bar 930.

FIG. 6E is a graph 1000 showing the days of supply (DOS-y-axis) for various store-item combinations (x-axis) produced in an exemplary embodiment. The line 1010 is the higher buffer value or higher safety stock value calculated by the buffer prediction system described herein. The line 1015 is the lower buffer value or lower safety stock value calculated by the buffer prediction system described herein. The line 1020 in graph 1000 represents other external factors that drive additional safety stock inventory to a store that may produce a slightly different inventory position than may be expected via the inputs into the buffer prediction system alone. Graph 1000 illustrates opportunities where current safety stock levels (represented by the bars) fall below the lower buffer value (line 1015) calculated by the buffer prediction system described herein. This indicates to a user that there is need to adjust the safety stock order to bring the buffer levels within compliance. The bars (e.g., 1025 and 1030) in the graph 1000 represent the inventory level for a particular product or item.

FIG. 6F is a graph 1100 showing the days of supply (DOS-y-axis) for various store-item combinations (x-axis) produced in an exemplary embodiment. The line 1110 is the higher buffer value or higher safety stock value calculated by the buffer prediction system described herein. The line 1115 is the lower buffer value or lower safety stock value calculated by the buffer prediction system described herein. The line 1120 in graph 1100 represents other external factors that drive additional safety stock inventory to a store that may produce a slightly different inventory position than may be expected via the inputs into the buffer prediction system alone. Graph 1100 illustrates opportunities where current safety stock levels (represented by the bars) are above the higher buffer value (line 1110) calculated by the buffer prediction system described herein. This indicates to a user that there is need to adjust the safety stock order to bring the buffer levels within compliance. In this case, the retail store is likely losing money by maintaining the higher than needed safety stock levels.

FIG. 6G is a graph 1200 showing the days of supply (DOS-y-axis) for various store-item combinations (x-axis) produced in an exemplary embodiment. The line 1210 is the higher buffer value or higher safety stock value calculated by the buffer prediction system described herein. The line 1215 is the lower buffer value or lower safety stock value calculated by the buffer prediction system described herein. The line 1220 in graph 1200 represents other external factors that drive additional safety stock inventory to a store that may produce a slightly different inventory position than may be expected via the inputs into the buffer prediction system alone. As can be seen, line 1220 falls below the tolerance level line 1215, and illustrates that not only is the current base buffer recommendation below the lower tolerance, but also that additional manual attempts to intervene have been insufficient to meet the safety stock values predicted by the buffer prediction system 100 described herein. Line 1220 depicts original system values adjusted to include manual interventions by users such as store manager, home office manager, etc. Graph 1200 illustrates opportunities where current safety stock levels (represented by the bars) fall below the lower buffer value (line 1215) calculated by the buffer prediction system described herein. This indicates to a user that there is need to adjust the safety stock order to bring the buffer levels within compliance. The bars (e.g., 1225 and 1230) in the graph 1200 represent the inventory level for a particular product or item.

FIG. 6H is a graph 1300 showing the days of supply (DOS-y-axis) for various store-item combinations (x-axis) produced in an exemplary embodiment. The line 1310 is the higher buffer value or higher safety stock value calculated by the buffer prediction system described herein. The line 1315 is the lower buffer value or lower safety stock value calculated by the buffer prediction system described herein. The line 1320 in graph 1300 represents other external factors that drive additional safety stock inventory to a store that may produce a slightly different inventory position than may be expected via the inputs into the buffer prediction system alone. Graph 1300 illustrates opportunities where current safety stock levels (represented by the bars) fall below the lower buffer value (line 1315) calculated by the buffer prediction system described herein. This indicates to a user that there is need to adjust the safety stock order to bring the buffer levels within compliance. The bars (e.g., 1325, 1330, and 1335) in the graph 1300 represent the inventory level for a particular product or item.

The following description is presented to enable any person skilled in the art to create and use a computer system configuration and related method and article of manufacture to predict buffer values for safety stock. Various modifications to the example embodiments will be readily apparent to those skilled in the art, and the generic principles defined herein may be applied to other embodiments and applications without departing from the spirit and scope of the invention. Moreover, in the following description, numerous details are set forth for the purpose of explanation. However, one of ordinary skill in the art will realize that the invention may be practiced without the use of these specific details. In other instances, well-known structures and processes are shown in block diagram form in order not to obscure the description of the invention with unnecessary detail. Thus, the present disclosure is not intended to be limited to the embodiments shown, but is to be accorded the widest scope consistent with the principles and features disclosed herein.

In describing exemplary embodiments, specific terminology is used for the sake of clarity. For purposes of description, each specific term is intended to at least include all technical and functional equivalents that operate in a similar manner to accomplish a similar purpose. Additionally, in some instances where a particular exemplary embodiment includes a plurality of system elements, device components or method steps, those elements, components or steps may be replaced with a single element, component or step. Likewise, a single element, component or step may be replaced with a plurality of elements, components or steps that serve the same purpose. Moreover, while exemplary embodiments have been shown and described with references to particular embodiments thereof, those of ordinary skill in the art will understand that various substitutions and alterations in form and detail may be made therein without departing from the scope of the invention. Further still, other embodiments, functions and advantages are also within the scope of the invention.

Exemplary flowcharts are provided herein for illustrative purposes and are non-limiting examples of methods. One of ordinary skill in the art will recognize that exemplary methods may include more or fewer steps than those illustrated in the exemplary flowcharts, and that the steps in the exemplary flowcharts may be performed in a different order than the order shown in the illustrative flowcharts.

What is claimed is:

1. A system for predicting a buffer value, the system comprising:
an input module configured to:
retrieve a quantity data value from a database for a receiving location associated with a processing location; and
receive a lower confidence value and a higher confidence value that present quantity data value is sufficient to meet a demand value;
a predictive analysis module configured to:
predict a lower buffer value for a period of time based on the lower confidence value and an effective lead time, the effective lead time is determined from a total processing time and a delivery time from the processing location to the receiving location;
predict a higher buffer value for the period of time based on the higher confidence value and the effective lead time,
wherein the lower and higher buffer values indicate a buffer quantity in addition to the present quantity data value to meet variations in the demand value;
receive a buffer data value that is more than the lower buffer value and less than the higher buffer value; and
an output module configured to:
automatically generate and process a request, at a server, for supplying the buffer data value to the processing location.

2. The system of claim 1, wherein the predictive analysis module predicts the lower buffer value and higher buffer value by calculating the lower buffer value and the higher buffer value based on a standard deviation of historical demand values, wherein the standard deviation of historical demand values is based on analysis of historical demand values for at least 13 weeks.

3. The system of claim 1, wherein the predictive analysis module predicts the lower buffer value and the higher buffer value based on current stock values at the receiving location.

4. The system of claim 3, wherein the current stock values at the receiving location are determined by automatic scanning of inventory at the receiving location.

5. The system of claim 1, the lower confidence value and the higher confidence value are user inputs.

6. The system of claim 1, wherein the effective lead time is determined at the server by analysis of historical effective lead times between the processing location and the receiving location.

7. The system of claim 1, wherein the predictive analysis module is configured to generate a user interface and display the predicted lower buffer value and the predicted higher buffer value in graphical format in the user interface.

8. The system of claim 1, wherein the request for supplying the buffer data value is generated for a specific day based on an actual lead time, wherein the actual lead time is total processing time and delivery time from a supply location to the processing location.

9. The system of claim 6, wherein the actual lead time is determined at the server by analysis of past actual lead times between the supply location and the processing location.

10. The system of claim 1, wherein the input module is configured to retrieve inventory data for a plurality of receiving locations associated with the processing location.

11. The system of claim 10, wherein the predictive analysis module is configured to predict the lower buffer value and the higher buffer value for each of the plurality of receiving locations, and the effective lead time is the total processing time and delivery time from the processing location to the respective receiving location.

12. The system of claim 11, wherein the predictive analysis module is configured to receive the buffer data value for each of the receiving locations, and the output module is configured to calculate a total buffer data value by aggregating the buffer data value for each of the receiving locations, and automatically generate and process the request for supplying the total buffer data value to the processing location.

13. A method for predicting a buffer value, the method comprising:
retrieving a quantity data value from a database for a receiving location associated with a processing location;
receiving a lower confidence value and a higher confidence value that present quantity data value is sufficient to meet a demand value;
predicting a lower buffer value for a period of time based on the lower confidence value and an effective lead time, the effective lead time is determined from a total processing time and a delivery time from the processing location to the receiving location;
predicting a higher buffer value for the period of time based on the higher confidence value and the effective lead time,
wherein the lower and higher buffer values indicate a buffer quantity in addition to the present quantity data value to meet variations in the demand value;
receiving a buffer data value that is more than the lower buffer value and less than the higher buffer value; and
automatically generating and processing a request, at a server, for supplying the buffer data value to the processing location.

14. The method of claim 13, wherein the lower buffer value and the higher buffer value are predicted based on a standard deviation of historical demand values, wherein the standard deviation of historical demand values is based on analysis of historical demand values for at least 13 weeks.

15. The method of claim 13, the lower confidence value and the higher confidence value are user inputs.

16. The method of claim 13, wherein the effective lead time is determined at the server by analysis of historical effective lead times between the processing location and the receiving location.

17. The method of claim 13, further comprising:
a user interface and display the predicted lower buffer value and the higher buffer value in graphical format in the user interface.

18. The method of claim 13, wherein the request for supplying the buffer data value is generated for a specific day based on an actual lead time, wherein the actual lead time is total processing time and delivery time from a supply location to the processing location.

19. The method of claim 18, wherein the actual lead time is determined at the server by analysis of past actual lead times between the supply location and the processing location.

20. A non-transitory machine readable medium storing instructions that when executed causes a processor to implement a method for predicting a buffer value, the method comprising:
retrieving a quantity data value from a database for a receiving location associated with a processing location;
receiving a lower confidence value and a higher confidence value that present quantity data value is sufficient to meet a demand value;
predicting a lower buffer value for a period of time based on the lower confidence value and an effective lead time, the effective lead time is determined from a total processing time and a delivery time from the processing location to the receiving location;
predicting a higher buffer value for the period of time based on the higher confidence value and the effective lead time,
wherein the lower and higher buffer values indicate a buffer quantity in addition to the present quantity data value to meet variations in the demand value;
receiving a buffer data value that is more than the lower buffer value and less than the higher buffer value; and
automatically generating and processing a request, at the server, for supplying the buffer data value to the processing location.
